(19) United States
(12) Patent Application Publication
(10) Pub. No.: US 2007/0124807 A1
(43) Pub. Date: May 31, 2007

(54) Password update systems and methods

(75) Inventor: Jack Jau, Baoshan Shiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/289,029

(22) Filed: Nov. 29, 2005

(51) Int. Cl. H04L 9/32

(52) U.S. Cl. 726/6

(57) ABSTRACT

A password exchange method. A server responds to requests received from a client when a client password received therefrom matches a current password stored in the password update system. A first password and a second password are received and stored by the server. When the server utilizes the first password as the current password, the client also utilizes the first password as the client password. When the first password expires, the server automatically utilizes of the second password as the current password. When a request from the client fails to be responded, the client retransmits the request utilizing the second password as the client password. A fab may thereby avoid throughput loss due to password expiration and update.

### BACKGROUND

The invention relates to computer communication techniques, and in particular, to password management.

Passage of the Sarbanes-Oxley Act (SOX) by the U.S. Congress has had a great impact on corporate data security. One result is that passwords of various systems must be updated periodically, giving rise to the issue of synchronizing password updates among computer networks.

In client server architecture, a server typically performs password identification before providing services to clients. A server and clients store password records. During the time interval between respective updates of the corresponding records within a server and a client, password identification and interactions therebetween will fail.

To avoid this problem, servers and clients shut down until password updates are complete. In a semiconductor manufacturing environment, however, some systems are so critical that, once shut down, wafer damage may occur resulting great yield loss and complicating password updates.

### SUMMARY

Accordingly, password update methods and systems are provided.

An exemplary embodiment of a password exchange method is implemented in a password update system comprising a server and a client coupled thereto. The server responds to requests received from the client when a client password received therefrom matches a current password stored in the password update system. A first password and a second password are received and stored by the server. When the server utilizes the first password as the current password, the client also utilizes the first password as the client password. The server determines the expiration date of the first password. When the expiration date of the first password arrives, the server automatically utilizes the second password as the current password. When a response to a request from the client fails, the client automatically utilizes the second password as the client password.

An exemplary embodiment of a password update system comprises a client and a server coupled thereto. The server responds to requests received from the client when a client password received therefrom matches a current password stored in the password update system. The server stores passwords corresponding to different expiration dates in a queue sorting the passwords by the expiration dates. When the expiration date of the current password arrives, the server automatically removes a password from the queue, utilizing the password as the current password. The server further determines the number of passwords in the queue and automatically displays a message requiring at least one new password according to the determination.

An exemplary embodiment of a password update system comprises a client and a server coupled thereto. The client comprises a client password. The server responds to requests received from the client when a client password received therefrom matches a current password stored in the password update system. The server receives and stores a first password and a second password. When the server utilizes the first password as the current password, the client also utilizes the first password as the client password. The server determines expiration date of the first password. When the expiration date of the first password arrives, the server automatically utilizes of the second password as the current password. When a response to a request from the client fails, the client automatically utilizes the second password as the client password.

### DESCRIPTION OF THE DRAWINGS

The invention can be more fully understood by reading the subsequent detailed description and examples with references made to the accompanying drawings, wherein:

FIG. 1 is a block diagram of a first embodiment of a password update system.

FIG. 2 is a block diagram of an exemplary embodiment of an semiconductor manufacturing environment.

FIG. 3 is a flowchart of a first embodiment of a password update method.

FIG. 4 is a schematic diagram of an exemplary embodiment of an interface receiving passwords.

FIG. 5 is a flowchart of an exemplary embodiment of spare password detection and password requirement alert.

FIG. 6 is a block diagram of a second embodiment of a password update system.

FIG. 7 is a flowchart of a second embodiment of a password update method.

### DETAILED DESCRIPTION

Password update systems and methods are provided.

### First Embodiment

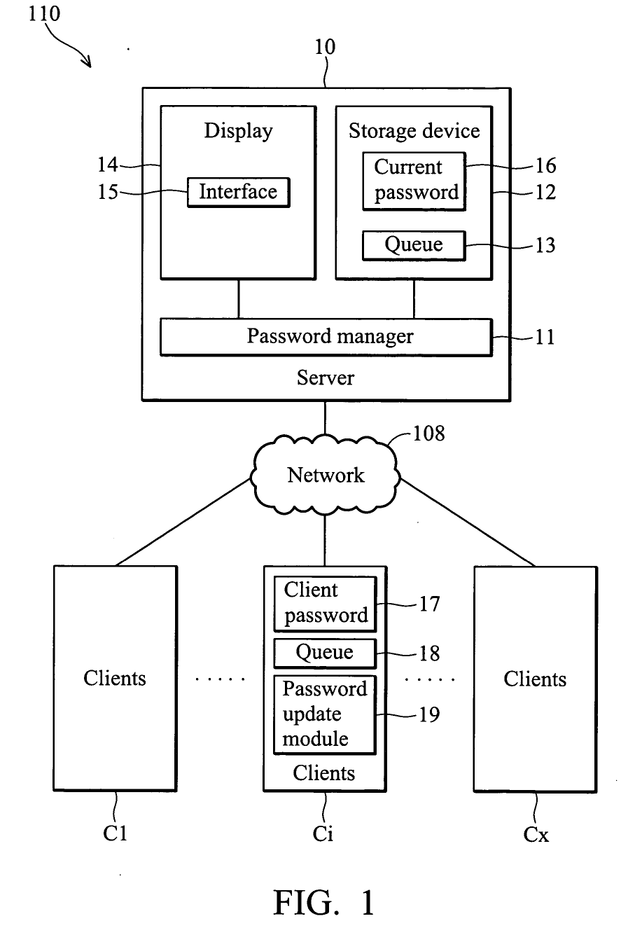

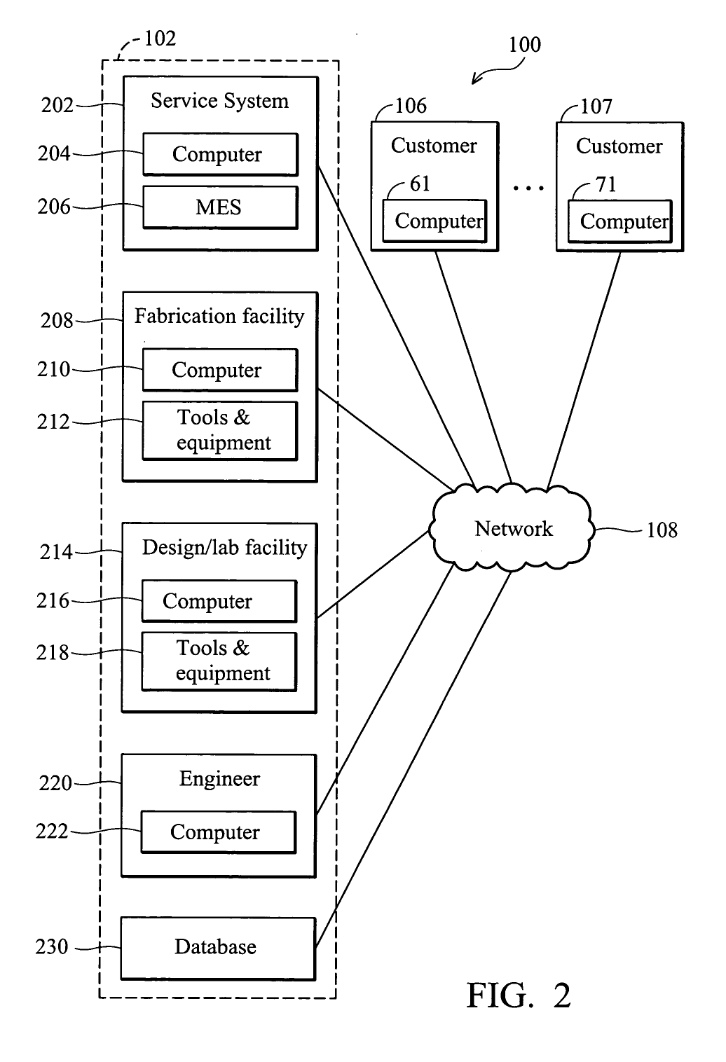

With reference to FIG. 1, password update system 110 comprising server 10 and clients C1-Cx coupled to network 108, which may comprise a local area network (LAN) or a wide area network (WAN). Server 10 comprises password manager 11, storage device 12, and display 14. Password manager 11 provides interface receiving and managing passwords. Queue 13 of storage device 12 stores passwords received by password manager 11. Each client comprises a password update module, such as password update module 19 in client Ci. Password update system 110 may be implemented in a semiconductor manufacturing environment, an exemplary embodiment of which is shown in FIG. 2.

In semiconductor manufacturing environment 100 of FIG. 2, semiconductor foundry 102 comprises a plurality of entities, each of which includes a computer coupled to other computers and customers (such as customers 106 and 107) through network 108. Network 108 may be the Internet or an intranet implementing network protocols, such as Internet Protocol (IP) and transmission control protocol (TCP). Customers 106-107 may be IC design companies or other entities for IC processing. Each computer included in the entities comprises a network interface.

Service system 202 is an interface between customers (such as customers 106 and 107) and semiconductor foundry 102, transferring information about semiconductor manufacturing. Service system 202 includes computer 204 facilitating such communication and manufacturing execution system (MES) 206.

MES 206, coupled to other systems and entities of semiconductor foundry 102, performs various operations to facilitate IC manufacture. For example, MES 206 can receive various real-time information, organize and store the information in a centralized database, manage work orders, workstations, manufacturing processes and relevant documents, and track inventory.

Database 230 is an exemplary storage unit storing various manufacturing information including work in process (WIP) information.

Fabrication facility 208 fabricates ICs. Accordingly, fabrication facility 208 includes fabrication tools and equipment 212. For example, tools and equipment 212 may comprise an ion implantation tool, a chemical vapor deposition tool, a thermal oxidation tool, a sputtering tool, various optical imaging systems, and software controlling the various tools and equipment. Fabrication facility 208 also includes computer 210.

Design/lab facility 214 conducts IC design and testing. Design/lab facility 214 comprises design/test tools and equipment 218. The tools and equipment 218 may comprise one or more software applications and hardware systems. Design/lab facility 214 also comprises computer 216.

Engineer 220 collaborates on IC manufacturing with other entities, such service system 202 and other engineers. For example, engineer 220 can collaborate with other engineers and the design/lab facility 214 on design and testing of ICs, monitor fabrication processes at the fabrication facility 208, and receive information regarding runs and yield. Engineer 220 also communicates directly with customers, using computer 222 to perform various operations.

Note that configuration of the entities of semiconductor foundry 102 is not limited to FIG. 2. They can be centralized in a single location or distributed. Some entities may be integrated into other entities. Server 10 may be one entity (such as a computer) in semiconductor manufacturing environment 100, and clients C1-Cx may be other entities therein. Each of clients C1-Cx may transmit request to server 10. Server 10 receives a request from a client and responds by providing services when a client password received from the client matches a current password stored in the password update system 110. For example, server 10 comprises database 230, and clients C1-Cx comprise computers 61-71, 206, 210, 216, and 222. Server 10 provides requested data to a client when the client passes password authentication performed by the server 10.

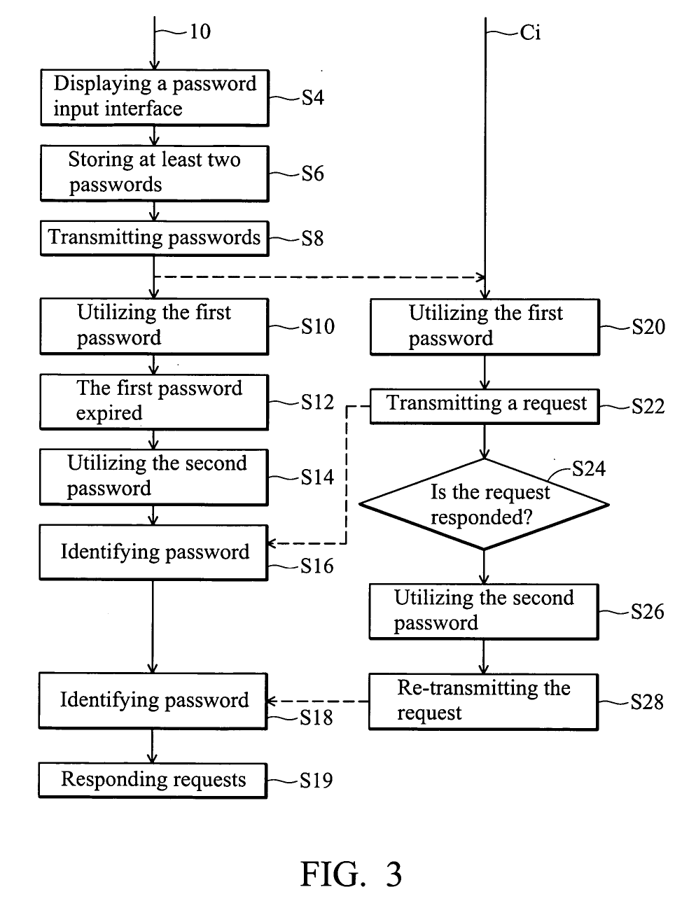

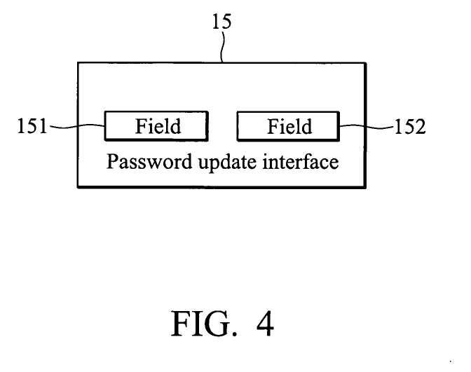

For clarity, only interactions between server 10 and client Ci are illustrated in FIG. 3. Server 10 provides an interface receiving passwords (step S4). For example, server 10 shows interface 15 on display 14. FIG. 4 shows an exemplary embodiment of interface 15 comprising fields 151 and 152. Note that interface 15 may have more fields for receiving passwords. Additionally, interface 15 may be a webpage transmitted by server 10 to a client and shown on a display thereof.

After fields 151 and 152 respectively receive a first password and a second password, server 10 retrieves the first password and the second password therefrom and stores the retrieved passwords in queue 13 (step S6). Each password corresponds to an expiration date stored in or dynamically determined by server 10. For example, the expiration date of the second password is later than the expiration date of the first password. Queue 13 sorts the passwords by their expiration dates and subsequently deletes passwords with a recent expiration date. Note that the first password, the second password, and expiration dates thereof may be stored elsewhere. Server 10 transmits the first password and the second password to clients C1-Cx (step S8). Clients C1-Cx receives and stores the first password and the second password. Password update module 19 stores the received passwords in queue 18, removes the first password from queue 18, and utilizes the first password as the client password of client Ci (step S20). Queue 18 sorts the passwords by the expiration dates thereof and subsequently deletes passwords with a recent expiration date. Note that server 10 may encrypt the first password and the second password before transmission thereof, and password update module 19 may decrypt the encrypted first password before step S20.

If server 10 stores no password before retrieving the first password and the second password, server 10 automatically removes the first password from queue 13 and utilizes the first password as current password 16 (step S10).

In the exemplary embodiment, a password may be utilized to authenticate different clients for different services. Different services, however, may correspond to different passwords for, client authentication. Different clients may utilize different passwords.

When client Ci transmits a request and client password 17 to server 10, server 10 receives the request and client password 17 of client Ci, which may be embedded in the request. Server 10 determines if client password 17 of client Ci matches current password 16. If so, server 10 responds to the request. If not, server 10 does not respond to the request. Password manager 11 periodically determines if the expiration date of current password 16 (i.e. the first password) arrives for each predetermined time interval. Current password 16 (i.e. the first password) expires when the expiration date thereof arrives.

When determining the expiration date of current password 16 (i.e. the first password) arrives (step S12), password update module 19 automatically utilizes the second password as current password 16 (step S14). After the second password is utilized as current password 16, client Ci transmits another request to server 10 (step S22). Server 10 receives the request from client Ci and identifies the client password thereof (step S16). The password identification fails because the client password is still the first password. Password update module 19 determines if the request is served (step S24). For example, when the request is not responded to after a predetermined period, password update module 19 determines that the request failure response is required.

When determining that responses to requests from the client have failed, password update module 19 automatically removes the second password from queue 18 and utilizes the second password as client password 17 (step S26). If the second password is encrypted, password update module 19 automatically decrypts the second password before step S26.

After the second password is utilized as client password 17 of client Ci, password update module 19 automatically directs the request to be transmitted to server 10 again or transmits another request for the same service as required by the previous request (step S28). Client Ci re-transmits a request to server 10 for the same service. Server 10 receives the request from client Ci and identifies client password 17 thereof (step S18). The password identification passes because client password 17 and current password 16 are both the same as the second password. Server 10 accordingly serves client Ci in response (step S19).

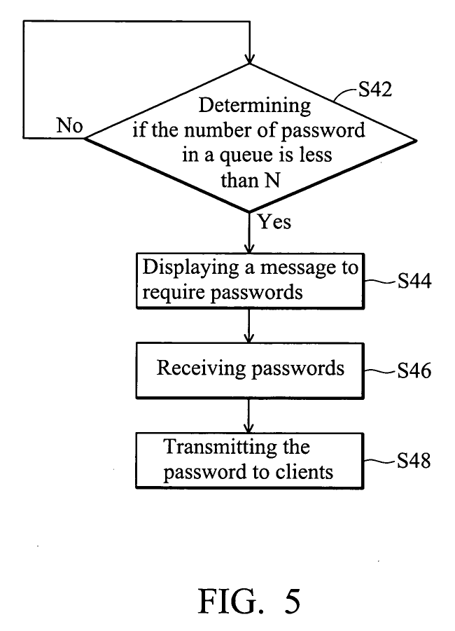

Password update system 110 automatically issues an alert before all passwords stored therein expire. For example, with reference to FIG. 5, password manager 11 automatically determines if the number of passwords in queue 13 is less than a threshold value N, which is an integer (step S42). If so, password manager 11 automatically displays a message (interface 15) to require new passwords (step S44), receives new passwords to be stored in queue 13 (step S46), and transmits the received passwords to clients C1-Cx (step S48). A protocol is set for password input to ensure that password update system 110 always has at least one spare password in addition to current password 16. When the threshold value N is 1, password manager 11 requires at least two passwords for each password input requirement. For example, password manager 11 shows interface 15 on display 14 until fields 151 and 152 receive different passwords. When the threshold value N is 2, password manager 11 requires at least one password for each password input requirement.

### Second Embodiment

Password update system 112 is similar to password update system 110 except for that which is described in the following.

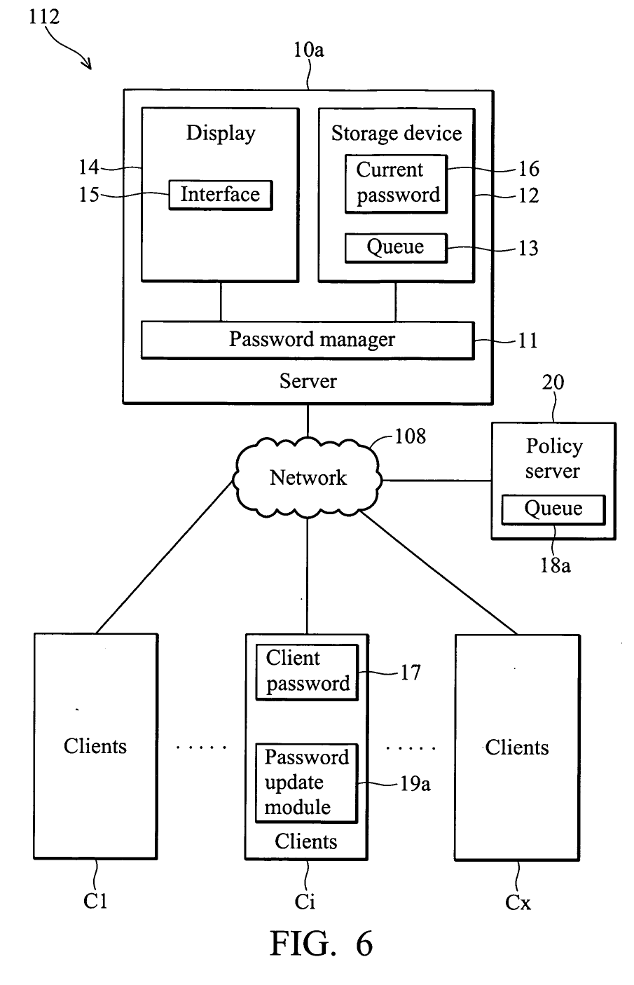

With reference to FIG. 6, policy server 20 coupled to clients C1-Cx and server 10a through network 108.

Each client comprises a password update module, such as password update module 19a in client Ci. Password update system 112 may be implemented in a semiconductor manufacturing environment.

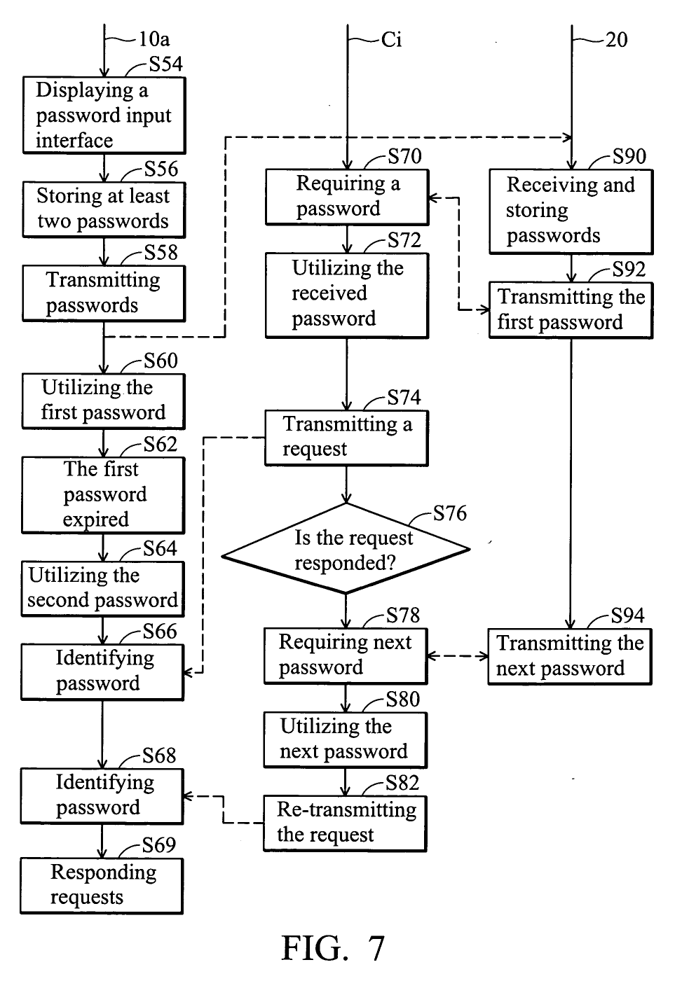

For clarity, only interactions among server 10a, client Ci, and policy server 20 are illustrated in FIG. 7. Server 10a provides an interface receiving passwords, such as interface 15 (step S54).

After fields 151 and 152 respectively receive a first password and a second password, server 10a retrieves the first password and the second password therefrom and stores the retrieved passwords in queue 13 (step S56). Each password corresponds to an expiration date stored in server 10a. Note that the first password, the second password, and expiration dates thereof may be stored elsewhere. Server 10a transmits the first password and the second password to policy server 20 (step S58). Policy server 20 receives and stores the first password and the second password in queue 18a (step S90).

If client Ci has no password, password update module 19a requests policy server 20 for a password in queue 18a (step S70). Policy server 20 transmits the first password to client Ci (step S92). Password update module 19a receives and stores the first password, and utilizes the first password as client password 17 of client Ci (step S72). Note that the first password and the second password may be encrypted by server 10a or policy server 20 before transmission thereof and decrypted by password update module 19a before step S72.

If server 10a stores no password before retrieving the first password and the second password, server 10a automatically removes the first password from queue 13 and utilizes the first password as current password 16 (step S60).

When client Ci transmits a request to server 10a, server 10a determines if client password 17 of client Ci matches current password 16. If so, server 10a responds to the request. If not, server 10a does not respond to the request. Password manager 11 periodically determines if expiration date of current password 16 (i.e. the first password) has arrived for a predetermined time interval. Current password 16 (i.e. the first password) expires when the expiration date thereof has arrived.

When determining the expiration date of current password 16 (i.e. the first password) arrives (step S62), password update module 19a automatically utilizes the second password as current password 16 (step S64). After the second password is utilized as current password 16, client Ci transmits another request to server 10a (step S74). Server 10a receives the request from client Ci and identifies client password 17 thereof (step S66). The password identification fails because client password 17 is still the first password. Password update module 19a determines if the request is served (step S76).

When determining that responses to requests from the client fail, password update module 19a automatically requests the next password in queue 18a of policy server 20, i.e. the second password (step S78). Policy server 20 transmits a next password (i.e. the second password) to the first password in queue 18a to client Ci (step S94). Password update module 19a receives the second password and utilizes the second password as client password 17 (step S80). If the second password is encrypted, password update module 19a automatically decrypts the second password before step S80.

After the second password is utilized as client password 17 of client Ci, password update module 19a automatically directs the request to be transmitted to server 10a again (step S82). Client Ci transmits the same request to server 10a. Server 10a receives the request from client Ci and identifies client password 17 thereof (step S68). The password identification passes because client password 17 and current password 16 are both the same as the second password. Server 10a accordingly serves client Ci in response (step S69).

Note that password encryption and decryption may utilize symmetric or asymmetric cryptography.

Thus, scheduled passwords with different expiration dates are reserved in a client-server system (such as password update systems 110 and 112). The server automatically updates passwords without downtime. When a request from a client fails to be served, the client automatically acquires a next password in the scheduled passwords as the client password thereof and re-transmits the request. Thus, clients also automatically update passwords without downtime. Additionally, a policy server may serve as a centralized database managing passwords.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A password exchange method, the server responds to requests received from the client when a client password received therefrom matches a current password stored in the password update system, comprising:
receipt and storage of a first password and a second password by the server;
when the server utilizes the first password as the current password, the first password is utilized as the client password by the client;
determination of an expiration date of the first password by the server;
when the expiration date of the first password arrives, the server automatically utilizes the second password as the current password; and
when a response to a client request fails, the client automatically utilizes the second password as the client password.

2. The method as claimed in claim 1, wherein after receiving the first password and the second password, the server automatically transmits the first password and the second password to the client.

3. The method as claimed in claim 1, wherein the server responds to the request by searching requested data from a database.

4. The method as claimed in claim 1, wherein after receiving the first password and the second password, the server transmits and stores the first password and the second password in a policy server coupled to the client and the server.

5. The method as claimed in claim 4, wherein when the request from the client fails to be responded, the client automatically retrieves the second password from the policy server.

6. The method as claimed in claim 5, wherein before transmitting the first password and the second password, the server automatically encrypts the first password and the second password.

7. The method as claimed in claim 1, wherein the server stores the first password and the second password in a queue, passwords therein comprise different expiration dates, before a password is utilized as a current password, the password is removed from the queue, when the queue is empty, the server automatically displays a message indicating that a new password is required.

8. The method as claimed in claim 7, wherein the password update system stores the expiration date of the second password, which is later than the expiration date of the first password.

9. The method as claimed in claim 8, wherein the client automatically transmits the request to the server again after utilizing the second password as the client password.

10. A password update system, comprising:
a client comprising a client password; and
a server coupled to the client, responding to requests received from the client when the client password received therefrom matches a current password stored in the password update system, storing passwords corresponding to different expiration dates in a queue sorting the passwords by the expiration dates, when expiration date of the current password arrives, automatically removing a password from the queue, utilizing the password as the current password, determining the number of passwords in the queue, and automatically displaying a message requiring at least one new password according to the determination.

11. The system as claimed in claim 10, wherein the server receives two new passwords for each password requirement and stores these two passwords in the queue.

12. The system as claimed in claim 11, wherein after the passwords are stored in the queue, the server automatically transmits the passwords to the client.

13. The system as claimed in claim 10, after storing the passwords in the queue, the server stores the passwords in a policy server coupled to the client and the server, and the client makes a request for one of the passwords from the policy server.

14. The system as claimed in claim 13, wherein when a response to a client request fails, the client retrieves a second password as the client password from the policy server.

15. The system as claimed in claim 14, wherein the client automatically transmits the request to the server again after utilizing the second password as the client password.

16. A password exchange system, comprising:
a client comprising a client password; and
a server coupled to the client, responding to requests received from the client when the client password received therefrom matches a current password stored in the password update system, receiving and storing a first password and a second password, utilizing the first password as the current password;
wherein the client utilizes the first password as the client password, the server determines expiration date of the first password, when the expiration date of the first password arrives, the server automatically utilizes the second password as the current password, and when a response to a client request fails, the client automatically utilizes the second password as the client password.

17. The system as claimed in claim 16, wherein after receiving the first password and the second password, the server automatically transmits the first password and the second password to the client.

18. The system as claimed in claim 16, wherein the server responds to the request by searching for requested data in a database.

19. The system as claimed in claim 16, wherein after receiving the first password and the second password, the server transmits and stores the first password and the second password in a policy server coupled to the client and the server.

20. The system as claimed in claim 19, wherein when the response to a client request fails, the client automatically retrieves the second password from the policy server.

21. The system as claimed in claim 20, wherein before transmitting the first password and the second password, the server automatically encrypts the first password and the second password.

22. The system as claimed in claim 16, wherein the server stores the first password and the second password in a queue, passwords therein comprise different expiration dates, before a password is utilized as the current password, the password is removed from the queue, when the queue is empty, the server automatically displays a message indicating that a new password is required.

23. The system as claimed in claim 22, wherein the password update system stores expiration date of the second password, which is later than the expiration date of the first password.

24. The system as claimed in claim 23, wherein the client automatically transmits the request to the server again after utilizing the second password as the client password.
